(19) United States
(12) Patent Application Publication
(10) Pub. No.: US 2025/0079693 A1
(43) Pub. Date: Mar. 6, 2025

(54) ANTENNA DEVICE FOR EMITTING ELECTROMAGNETIC RADIATION FOR A MOTOR VEHICLE, AND MOTOR VEHICLE

(71) Applicants: Volkswagen Aktiengesellschaft, Wolfsburg (DE); Fraunhofer Gesellschaft zur Förderung der angewandten Forschung e.V., Munich (DE)

(72) Inventors: Heiko Gustav Kurz, Hannover (DE); Marc-Michael Meinecke, Sassenburg (DE); Renato Simoni, Bonn (DE); María Antonia González-Huici, Bonn (DE); Christian Greiff, Bonn (DE); David Mateos-Nunez, Alcala de Henares (ES); Thomas Gisder, Wolfsburg (DE); Andreas Danklmayer, Grafschaft (DE); Stephan Kruse, Paderborn (DE); Julien Ladan, Braunschweig (DE)

(21) Appl. No.: 18/811,551

(22) Filed: Aug. 21, 2024

(30) Foreign Application Priority Data
Aug. 31, 2023 (DE) 102023208400.7

(51) Int. Cl. H01Q 1/32; G01S 13/931

(52) U.S. Cl. CPC H01Q 1/3233; G01S 13/931; H01Q 1/3275; H01Q 1/3283; G01S 2013/93273; G01S 2013/93275

(57) ABSTRACT

An antenna device for emitting and/or receiving electromagnetic radiation in a motor vehicle includes at least two sub-antenna groups arranged at a predefined first distance relative to one another. Each sub-antenna group includes at least one transmitting antenna and one receiving antenna, with a second distance between the at least one transmitting antenna and the one receiving antenna being smaller than the predefined first distance between the sub-antenna groups. This description also relates to a motor vehicle that incorporates the antenna device.

### RELATED APPLICATIONS

The present application claims priority to German Patent Application No. 10 2023 208 400.7, to Kurz, et al., filed Aug. 31, 2023, the contents of which is incorporated by reference in its entirety herein.

### TECHNICAL FIELD

The present disclosure relates to an antenna device for emitting electromagnetic radiation in a motor vehicle, comprising at least two sub-antenna groups arranged to be spaced a predefined first distance apart from one another, as described herein. The present disclosure also relates to a motor vehicle that includes such an antenna device.

### BACKGROUND

Antenna devices comprising a plurality of sub-antenna groups, such as transmitting antennas or receiving antennas, are generally known in the prior art. Existing radar antenna installations distributed across a large surface area are based on the concept of distributed radiating elements, which are dispersed over the entire aperture using a specific optimization method. This arrangement includes a combination of transmitting and receiving antennas.

While this setup produces a powerful array, it has several disadvantages, including the need for a high number of connecting lines and fibers. Additionally, this arrangement necessitates the production of various electronic and photonic integrated (EPIC) chips, leading to a costly system that may be economically prohibitive. Furthermore, previously known solutions require a larger installation space and have higher weight requirements.

Other drawbacks in the prior art involve challenges with the calibration of individual antenna positions within the distributed antenna array. Phase ambiguities can make the calibration process complex. Angular ambiguities, coupled with issues arising from high side lobes in the radiation pattern, are also observed. Additionally, the search for corresponding target peaks in individual spectra and their association between different antennas can be problematic. The need to maintain a high number of different hardware modules or corresponding EPIC chips adds to the unattractiveness of this solution. Moreover, a complex system architecture is necessary.

For example, DE 10 2019 134 304 A1 describes a radar system and a method for operating it. The radar system includes a plurality of transmitting antennas for transmitting radar signals to a monitoring region, a plurality of receiving antennas for receiving echoes of radar signals reflected in the monitoring region, and at least one antenna electronics unit to which the transmitting and receiving antennas are connected via antenna feed lines. Some antennas are arranged in groups, with respective phase centers along at least one antenna orientation axis. In some configurations, transmitting antennas with phase centers on the same orientation axis are grouped, with a phase center distance smaller than the distance between the centers of adjacent transmitting antenna groups.

Similarly, US 2020/153122 A1 discloses an antenna array apparatus comprising first antenna elements arranged to form a first radiation pattern with a recessed portion at the center, and second antenna elements arranged to form a second radiation pattern with a convex portion at the center.

WO 2014/004505 A1 describes a device for determining the position of a target object using a two-channel monopulse radar. The radar device may include two transmitting antennas and a shared receiving antenna in a coplanar arrangement. The transmitting antennas can be positioned on the radar's focal plane along an axis perpendicular to the radar's boresight, spaced apart by a distance equal to approximately one-half of one wavelength of the radar's center operating frequency. The antennas can be angled relative to the boresight in different dimensions but are not squinted relative to one another in the first dimension.

### SUMMARY

The present disclosure is directed to creating an antenna device and a motor vehicle that can achieve a large aperture for a motor vehicle.

Certain aspects are disclosed in the subject matter of the independent claims, while further implementations and preferred embodiments are detailed in the dependent claims.

In some examples, the present disclosure relates to an antenna device for emitting and/or receiving electromagnetic radiation in a motor vehicle, comprising at least two sub-antenna groups arranged at a predefined first distance from one another.

In some examples, each sub-antenna group comprises at least one transmitting antenna and one receiving antenna, wherein a second distance between the at least one transmitting antenna and the one receiving antenna is smaller than the predefined first distance between the sub-antenna groups.

Another aspect of the present disclosure relates to a motor vehicle comprising at least one antenna device as described above.

Advantageous specific embodiments of the antenna device shall also be considered advantageous specific embodiments of the motor vehicle.

The present disclosure also encompasses combinations of the features described in the embodiments.

### BRIEF DESCRIPTION OF THE DRAWINGS

Exemplary embodiments of the present disclosure are described hereafter. In the drawings:

FIG. 1 shows a front view of a motor vehicle comprising an antenna device, according to some aspects of the present disclosure;

FIG. 2 shows a schematic rear view of a motor vehicle comprising an antenna device, according to some aspects of the present disclosure;

FIG. 3 shows a schematic side view of a motor vehicle comprising an antenna device, according to some aspects of the present disclosure;

FIG. 4 shows a schematic block diagram according to an embodiment of an antenna device, according to some aspects of the present disclosure; and

FIG. 5 shows a schematic block diagram of a sub-group of an antenna device, according to some aspects of the present disclosure.

### DETAILED DESCRIPTION

The exemplary embodiments described hereafter are preferred examples of the present disclosure. In these examples, the described components represent individual features that are to be considered independently of one another. Each feature may also refine the present disclosure independently and should be regarded as an integral part of the disclosure, whether individually or in combination with other features beyond those shown. Additionally, the described exemplary embodiments may be supplemented with additional features described herein.

In the figures, functionally equivalent elements are denoted by the same reference numerals.

In some examples, the implementation of a large antenna array can be achieved with an optimized arrangement of radar antennas, for instance. Skillful grouping of antenna elements into sub-groups is introduced, allowing for a reduction in the number of different components and the use of a larger number of identical parts. This approach also reduces the number of connecting lines required.

For instance, a single sub-group is capable of enabling angular measurement. This can be achieved when at least two transmitting antennas and one receiving antenna, or two receiving antennas and one transmitting antenna, are installed. Angular ambiguity and angular resolution are significant considerations in this context. The angular resolution is achieved through the interconnection of several spread-out sub-groups. From the perspective of angular measurement characteristics, the sub-groups can generally be considered calibrated under all circumstances. Each sub-group with corresponding antennas requires fewer feed lines than separately installed antennas. For example, a sub-group can also be implemented with different quantities of antenna elements. The number of channels can be further varied, with the number of phases scaled proportionally to the number of antennas.

By grouping the sub-groups, fewer antennas need to be installed than in conventional configurations, which offers advantages in serial production. Additionally, the electrical power consumption of the sub-groups is reduced compared to prior approaches. Data transmission can also be carried out using fewer phases. By employing multiplexing methods, such as IQ modulation, FDMA, TDMA, or the like, and possibly optical circulators, reception data from multiple antennas or even transmission data and diagnostic and control information can be transmitted via a phase, further reducing the complexity of the antenna device. The sub-groups can also be configured as either a uniform array or a non-uniform array. In this context, uniform antennas refer to configurations with equidistant antennas.

According to an advantageous embodiment, the second distance essentially corresponds to half a wavelength of the emitted electromagnetic radiation, denoted by λ. In some examples, the second distance is therefore approximately λ/2. In an advantageous embodiment, the individual antennas within the sub-groups are implemented at a distance of approximately λ/2, where λ represents the wavelength of the emitted electromagnetic radiation. However, any number of antennas can form a sub-group, which may also be positioned at multiples of approximately λ/2. Alternatively, the antennas may be positioned at distances ranging from λ/2 to several λ. This configuration allows for reliable reception of electromagnetic radiation. It may also be advantageous when a sub-antenna group includes at least one additional transmitting antenna and/or one additional receiving antenna. A sub-antenna group may thus include at least three antennas. For example, two transmitting antennas and one receiving antenna, or at least one transmitting antenna and two receiving antennas, can be provided. This configuration enables a particularly high angular resolution.

It may also be advantageous when each transmitting antenna and/or each receiving antenna is configured as an electronic and photonic integrated chip (EPIC). EPICS, particularly those using silicon photonics technology, integrate electronic and photonic components on a single chip. This allows for the monolithic integration of photonic components, high-frequency electronics, and digital electronics on one chip. Notably, this enables the transmission of gigahertz signals via an optical carrier signal in the IR THz frequency range. A central station generates an optical carrier frequency (THz), and the signal to be transmitted is modulated at, for example, 1/n of the radar frequency. It is then transmitted to the corresponding antenna chips via optimized fibers, where the frequency is multiplied, allowing the original signal to be emitted by the antenna chips at the multiplied frequency. Signal detection occurs through the reverse process, with all data processed at the central station. This configuration provides an improved antenna array.

It may also be advantageous when the at least two sub-antenna groups are interconnected to form a coherent antenna device. The antenna device can reliably carry out surroundings detection, such as using radar technology.

According to another advantageous embodiment, the antenna device is configured for a communication device of the motor vehicle. For example, communication with a satellite can be facilitated by the antenna device, allowing it to be used in a highly flexible manner.

In another advantageous embodiment, the antenna device is configured for a radar device of the motor vehicle. For instance, the radar device can be used in an assistance system of the motor vehicle, enabling improved surroundings detection for at least partially or fully assisted operation.

In another advantageous embodiment, a sub-antenna group includes at least one transmitting antenna and three receiving antennas. These antennas are ideally installed at the second distance, preferably at a distance of λ/2. This configuration directly addresses angular measurement ambiguity over, for example, the required 180° in a radar device. By increasing the number of antennas, improved precision is achieved compared to prior art, particularly in azimuth angle measurement, as well as a gain in the signal-to-noise ratio.

Furthermore, it may also be advantageous when at least one of the sub-groups is implemented in a bumper, glazing device, or roof device of the motor vehicle. This allows the antenna device to be installed flexibly in the motor vehicle, for example, for communication or surroundings detection in the form of a radar device. Thus, the antenna device can be used flexibly in the motor vehicle.

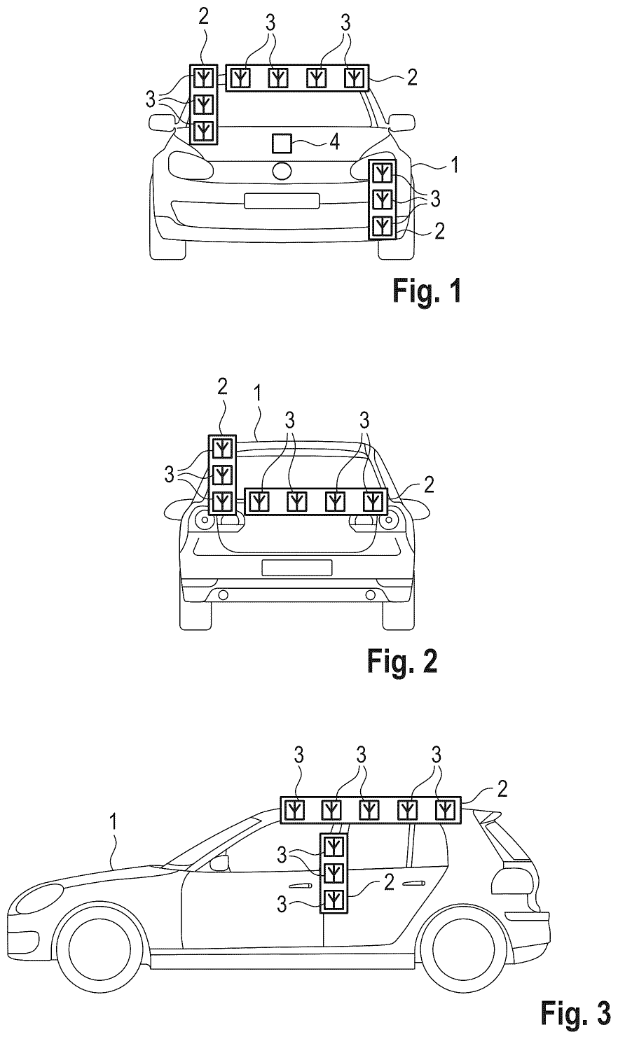

FIG. 1 shows a schematic front view of one example of a motor vehicle 1. In this example, the motor vehicle 1 comprises at least one antenna device 2. In this example, the motor vehicle 1 includes at least three antenna devices 2. For instance, a first antenna device 2 can be arranged in a bumper of the motor vehicle 1, a second antenna device 2 can be arranged in a glazing device of the motor vehicle 1, such as the windshield, and a third antenna device 2 can be arranged on the roof of the motor vehicle 1.

FIG. 1 also shows that the antenna device 2 comprises at least two sub-groups 3. Additionally, it is possible for the antenna device 2 to include more than two sub-groups 3. Furthermore, it is shown that the motor vehicle 1 in this example comprises an assistance system 4. For example, the antenna device 2 may be configured as a radar device for the assistance system 4. Alternatively or additionally, the antenna device 2 may also be configured as a communication device for the motor vehicle 1.

FIG. 2 shows a schematic view of the motor vehicle 1. This example, in particular, illustrates that a corresponding antenna device 2 may also be configured with respective sub-groups 3 on the rear.

FIG. 3 shows a schematic side view according to one example of the motor vehicle 1. In this example, it is shown, in particular, that the antenna device 2 can be positioned on the roof or on a side of the motor vehicle 1.

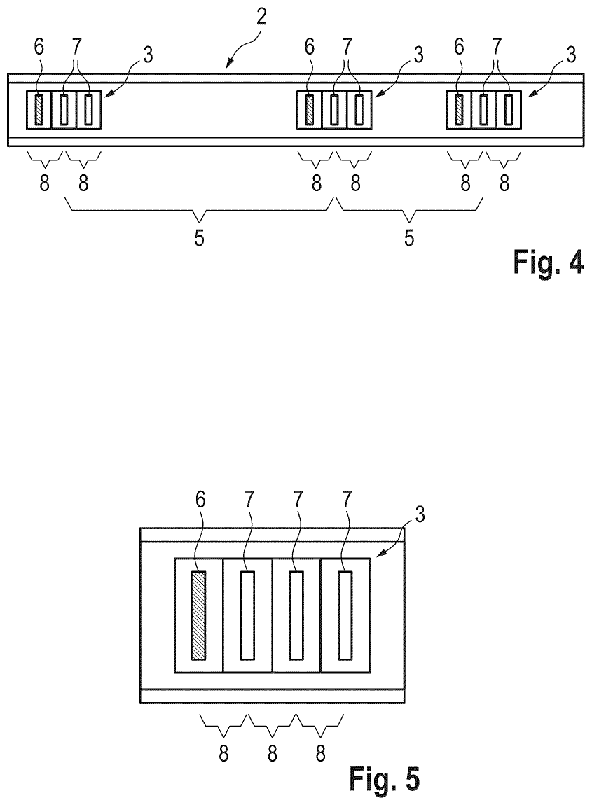

FIG. 4 shows a schematic block diagram of an antenna device 2. In this example, it is shown, in particular, that the antenna device 2 comprises at least three sub-groups 3.

FIG. 4, in particular, illustrates one configuration of the antenna device 2 for emitting and/or receiving electromagnetic radiation for the motor vehicle 1, comprising at least two sub-antenna groups 3 arranged at a predefined first distance 5 from one another. It is configured that each sub-antenna group 3 comprises at least one transmitting antenna 6 and one receiving antenna 7, wherein a second distance 8 between the at least one transmitting antenna 6 and the one receiving antenna 7 is smaller than the predefined first distance 5 between the sub-antenna groups 3.

In particular, FIG. 4 shows that different first distances 5 can also be formed between the sub-antenna groups 3.

FIG. 4 also shows that the second distance 8 essentially corresponds to half a wavelength of the emitted electromagnetic radiation. FIG. 4 further shows that a sub-antenna group 3 comprises at least one second transmitting antenna and/or one second receiving antenna 7. In this example, it is shown, in particular, that a sub-antenna group 3 may comprise one transmitting antenna 6 and two receiving antennas 7. Furthermore, it may also be configured that each transmitting antenna 6 and/or each receiving antenna 7 is an electronic and photonic integrated chip. FIG. 4 further shows that the at least two sub-antenna groups 3 are interconnected to form a coherent antenna device 2.

When configured as an electronic and photonic integrated chip (EPIC) and distributed over a large surface area on the vehicle surface, coherent signal processing of the individual antennas 6, 7 can provide resolving power in the range of 0.1 degrees.

The radiation pattern of the antennas 6, 7 is determined by fundamental physical principles. For example, planar antennas, which are widely used today, typically emit most of their power perpendicular to the surface. This characteristic is a direct result of their design and the underlying physics. For example, planar antennas 6, 7, which are already widely used today, offer a major advantage due to their very space-saving installation depth, which can be implemented on printed circuit boards (PCBs). However, these forms of antenna designs generally emit most of the power perpendicular to the surface. Pivoting a beam within a range of approximately 60 degrees cannot be implemented in a technologically meaningful manner. As mentioned earlier, today's radar antennas for ACC operation and the required angular resolution typically have dimensions of 6 cm×8 cm. Installation space for such sensors can be located relatively easily in various spots in the vehicle.

In contrast to the antenna geometries required for assisted and semi-automated driving functions, the angular resolution needed for highly automated vehicles is much finer, for example, in the range of 0.1 degrees. According to physical relationships, the resulting antenna size is approximately 1.2 m. In some circumstances, no suitably large surface areas are available on automotive body shells for such antenna sizes. Consequently, innovative antenna concepts are needed. According to the present disclosure, an antenna 6, 7 is applied to a large, substantially planar surface area, such as a glass surface. Alternatively, integration into large, not necessarily planar components, such as bumpers or plastic bumper guards, may be considered.

For example, EPIC chips can be used for this purpose. The electronic and photonic integrated chips (EPIC) integrate electronic and photonic components, particularly using silicon photonics technology. This enables the monolithic integration of photonic components, high-frequency electronics, and digital electronics on a single chip. Notably, this allows for the transmission of gigahertz signals via an optical carrier signal in the IR THz frequency range. A central station generates an optical carrier frequency (THz). The signal to be transmitted is modulated at, for example, 1/n of the radar frequency on this optical carrier frequency and is transmitted to the corresponding antenna chips via optimized fibers. On these chips, the frequency is multiplied so that the radiation can be emitted in its original form but with a multiplied frequency. Signal detection occurs through the reverse process, with all data processed at the central station. This configuration provides an improved antenna array.

FIG. 4 shows a simple configuration of a sub-antenna module 3, comprising one transmitting antenna 6 and two receiving antennas 7. These antennas 6, 7 are advantageously installed in close proximity to one another, ideally at a distance corresponding to a spatial increment based on approximately half the wavelength of the underlying transmitting frequency. This configuration directly yields unambiguity in the angular measurement over the required 180°.

Similarly to the example shown in FIG. 4, a sub-antenna group 3 may also be configured to comprise two transmitting antennas and one receiving antenna. These antennas are advantageously installed in close proximity to one another, ideally at a distance of λ/2. This configuration directly yields unambiguity in the angular measurement over the required 180 degrees.

FIG. 5 shows another example of a sub-antenna group 3. In this example, the sub-antenna group 3 may comprise one transmitting antenna 6 and three receiving antennas 7. These antennas are advantageously installed in close proximity to one another, ideally at a distance of approximately λ/2. This configuration directly yields unambiguity in the angular measurement over the required 180 degrees. By increasing the number of antennas 6, 7, the precision in azimuth angle measurement is improved compared to the prior art shown in FIG. 4, along with a gain in the signal-to-noise ratio.

Further examples of the sub-antenna group 3 can be constructed with configurations including transmitting antennas 6 with a factor of m and receiving antennas 7 with a factor of n, where m and n are elements of the natural numbers and m+n≥1.

### List of Reference Numerals

1 motor vehicle
2 antenna device
3 sub-antenna group
4 assistance system
5 first distance
6 transmitting antenna
7 receiving antenna
8 second distance

1. An antenna device for emitting and/or receiving electromagnetic radiation in a motor vehicle, the antenna device comprising:
at least two sub-antenna groups configured at a predefined first distance from one another,
wherein each sub-antenna group comprises at least one transmitting antenna and one receiving antenna, and a second distance between the at least one transmitting antenna and the one receiving antenna is smaller than the predefined first distance between the sub-antenna groups.

2. The antenna device of claim 1, wherein the second distance is approximately half a wavelength of the emitted electromagnetic radiation.

3. The antenna device of claim 1, wherein each sub-antenna group includes at least one second transmitting antenna and/or one second receiving antenna.

4. The antenna device of claim 1, wherein each transmitting antenna and each receiving antenna is configured as an electronic and photonic integrated chip.

5. The antenna device of claim 1, wherein the at least two sub-antenna groups are interconnected to form a coherent antenna device.

6. The antenna device of claim 1, wherein the antenna device is configured for a communication system of the motor vehicle.

7. The antenna device of claim 1, wherein the antenna device is configured for a radar system of the motor vehicle.

8. The antenna device of claim 1, wherein each sub-antenna group includes at least one transmitting antenna and three receiving antennas.

9. The antenna device of claim 1, wherein at least one of the sub-antenna groups is positioned in a bumper, a glazing device, or a roof of the motor vehicle.

10. A motor vehicle comprising:
at least one antenna device configured to emit and/or receive electromagnetic radiation, the antenna device comprising:
at least two sub-antenna groups configured at a predefined first distance from one another,
wherein each sub-antenna group includes at least one transmitting antenna and one receiving antenna, and a second distance between the at least one transmitting antenna and the one receiving antenna is smaller than the predefined first distance between the sub-antenna groups.

11. The motor vehicle of claim 10, wherein the second distance is approximately half a wavelength of the emitted electromagnetic radiation.

12. The motor vehicle of claim 10, wherein each sub-antenna group includes at least one second transmitting antenna and/or one second receiving antenna.

13. The motor vehicle of claim 10, wherein each transmitting antenna and each receiving antenna is configured as an electronic and photonic integrated chip.

14. The motor vehicle of claim 10, wherein the at least two sub-antenna groups are interconnected to form a coherent antenna device.

15. The motor vehicle of claim 10, wherein the antenna device is configured for a communication system of the motor vehicle.

16. The motor vehicle of claim 10, wherein the antenna device is configured for a radar system of the motor vehicle.

17. The motor vehicle of claim 10, wherein each sub-antenna group includes at least one transmitting antenna and three receiving antennas.

18. The motor vehicle of claim 10, wherein at least one of the sub-antenna groups is positioned in a bumper, a glazing device, or a roof of the motor vehicle.

19. A method for operating an antenna device in a motor vehicle, the method comprising:
arranging at least two sub-antenna groups at a predefined first distance from one another;
configuring each sub-antenna group to include at least one transmitting antenna and one receiving antenna; and
setting a second distance between the at least one transmitting antenna and the one receiving antenna to be smaller than the predefined first distance between the sub-antenna groups.

20. The method of claim 19, further comprising:
setting the second distance to be approximately half a wavelength of the emitted electromagnetic radiation.
